(19) United States
(12) Patent Application Publication
(10) Pub. No.: US 2015/0335158 A1
(43) Pub. Date: Nov. 26, 2015

(54) MONITOR BRACKET ASSEMBLY

(71) Applicants: Midlake Products & Manufacturing Company, Louisville, OH (US); Global Infrastructures Solutions, Inc., Arvada, CO (US)

(72) Inventor: Kenneth Leo Grosswiller, Louisville, OH (US)

(73) Assignees: MIDLAKE PRODUCTS & MANUFACTURING COMPANY; GLOBAL INFRASTRUCTURES SOLUTIONS, INC.

(21) Appl. No.: 14/524,135

(22) Filed: Oct. 27, 2014

Related U.S. Application Data
(60) Provisional application No. 62/002,534, filed on May 23, 2014.

(51) Int. Cl. A47B 97/00; F16M 13/02

(52) U.S. Cl. CPC A47B 97/00; F16M 13/022; A47B 2097/005; A47B 2097/003

(57) ABSTRACT

A monitor bracket assembly is adapted to deploy four monitors respectively attached to first, second, third, and fourth monitor frames from a folded and stored first position to an unfolded 2×2 second position. The monitor bracket assembly includes a first monitor frame, a second monitor frame, a third monitor frame, and a fourth monitor frame. A generally transverse frame first hinge pivotably couples the first monitor frame to the second monitor frame. A generally transverse frame second hinge pivotably couples the third monitor to frame to the fourth monitor frame. A generally vertical frame third hinge pivotably couples the second monitor frame to the third monitor frame.

### CROSS-REFERENCE TO RELATED APPLICATION

This application claims priority from U.S. Provisional Application Ser. No. 62/002,534, filed May 23, 2014, the disclosure of which is incorporated herein by reference.

### BACKGROUND OF THE INVENTION

1. Field of Invention

The current invention relates generally to apparatus, systems and methods for displaying images and information. More particularly, the apparatus, systems and methods relate to a system of multiple monitors mounted in a housing. Specifically, the apparatus, systems and methods provide for a monitor bracket assembly for storing four monitors in a case that houses and the bracket assembly to unfold the four monitors mounted to respective frames to form a 2×2 monitor display.

2. Description of Related Art

Since the invention of television and later computers, monitors are used to display images and information associated with these devices. Original monitors were cathode ray tube (CRT) monitors. The CRT monitors have a vacuum tube containing one or more electron guns (a source of electrons or electron emitter) and a fluorescent screen used to view images. CRT monitors have a means to accelerate and deflect the electron beam(s) onto the screen to create the images. The images may represent electrical waveforms (oscilloscope), pictures (television, computer monitor), radar targets or other types of images. The CRT uses an evacuated glass envelope which is large, deep (i.e. long from front screen face to rear end), fairly heavy, and relatively fragile. As a matter of safety, the face is typically made of thick lead glass so as to be highly shatter-resistant and to block most X-ray emissions, particularly if the CRT is used in a consumer product.

Currently, CRTs have largely been superseded by newer display technologies such as liquid crystal display (LCD) and plasma displays which have lower manufacturing costs, power consumption, weight and bulk. However, these newer monitors are often made of plastic and are generally intended for indoor use. Also, these monitors are for desktop use and therefor are often sized accordingly for that use, and do not have a screen that is large enough for use outdoors in the field. What is needed is a better display for images and information.

One attempt at providing an improved way of displaying images is available and known as a “3-by-one-plus-one” or “3×1+1”. These 3×1+1 systems have a row of three LCD monitors with an additional LCD monitor positioned above the central monitor in the row of three. Some 3×1+1 systems include hinges between the monitor allowing them to pivot. In the hinged 3×1+1 system there are two vertical hinges and one horizontal hinge; a vertical first hinge connecting the central monitor to a right side monitor, a vertical second hinge connecting the central monitor to a left side monitor, and a horizontal third hinge connecting the central monitor to the top “plus one” monitor.

### SUMMARY

Issues continue to exist with these image display systems, particularly the 3×1+1 system, inasmuch as they do not provide a rectangular viewing area for 4 individual views or scaling for 1 view across multiple LCD Panels, as users have come to enjoy and prefer. The present invention addresses these and other issues.

An aspect of one embodiment of the invention may include a monitor bracket assembly comprising: a first monitor frame; a second monitor frame; a third monitor frame; a fourth monitor frame; a generally transverse or horizontal frame first hinge pivotably coupling the first monitor frame to the second monitor frame; a generally transverse or horizontal frame second hinge pivotably coupling the third monitor to frame to the fourth monitor frame; and a generally vertical frame third hinge pivotably coupling the second monitor frame to the third monitor frame; wherein the monitor bracket assembly is adapted to deploy four monitors respectively attached to the first, second, third, and fourth monitor frames from a folded and stored first position to an unfolded 2×2 second position.

An additional aspect of an embodiment of the invention may include a method comprising the steps of: providing a monitor bracket assembly mounted in a case to a user, wherein the bracket assembly configured to move between a folded and stored first position to an unfolded 2×2 second position; effecting the user to longitudinally draw a monitor frame on the bracket assembly in a stored position outwardly from the case; and effecting the user to pivot the monitor frame about a hinge to deploy the frame associated with the unfolded 2×2 position.

### BRIEF DESCRIPTION OF SEVERAL VIEWS OF THE DRAWINGS

The accompanying drawings, which are incorporated in and constitute a part of the specification, illustrate various example methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is an isometric top view of a transportable 2×2 monitor device in accordance with one aspect of an embodiment of the present invention;

FIG. 2 is an isometric top view of the monitor bracket assembly of the present invention deployed from a case;

FIG. 3 is a front elevation view of the monitor bracket assembly of the present invention shown in an unfolded 2×2 position;

FIG. 4 is a left side elevation view of the unfolded monitor assembly;

FIG. 5 is a rear-elevation view of the unfolded monitor assembly with a back cover removed from the case;

FIG. 6 is a front elevation view of the monitor assembly of the present invention in a stored position within the case and a shroud covering a lower portion of the stored monitor assembly of the present invention.

FIG. 7 is a front elevation view of the stored monitor assembly of the present invention with the shroud removed;

FIG. 8 is a cross section view taken along line 8-8 in FIG. 7 depicting three pairs of rails telescopingly cooperating in a collapsed position;

FIG. 9 is a left side view of the monitor bracket assembly of the present invention being extracted out of the case;

FIG. 10 is a top view with the monitor bracket assembly extracted from the case and a compression strap being unlocked;

FIG. 11 is a front elevation view depicting the monitor bracket assembly being rotated 90° upward about a longitudinal hinge and a moveable rear support arm being locked into place;

FIG. 12 is a top view of the monitor bracket assembly in the position of FIG. 11 and depicting a K-bracket swung about a vertical axis into position and a twist latch being undone;

FIG. 13 is a front elevation view depicting the K-bracket installed to support a monitor support plate and a compression latch hanging freely;

FIG. 14 is a top view depicting the four monitor frames being swung 90° about a vertical axis.

FIG. 15 is a top view depicting two of the four frames being released and swung about a vertical axis to create a transverse plane;

FIG. 15A is a top view of the case and the extracted monitor bracket assembly depicting the wire assembly and two springs that support the wires;

FIG. 16 is a left side view of the present invention in the position of FIG. 15; and

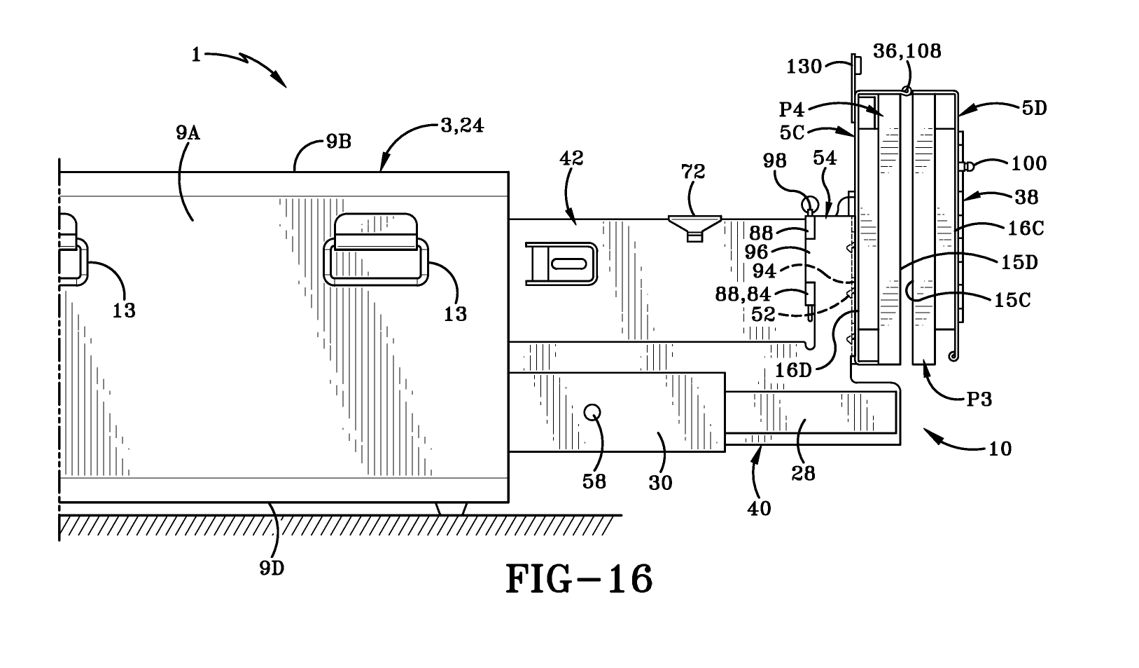

FIG. 17 is an operational left side view of the present invention depicting two monitor frames being rotated upwardly about a transverse axis and the slides being pushed into the case.

Similar numbers refer to similar parts throughout the drawings.

### DETAILED DESCRIPTION

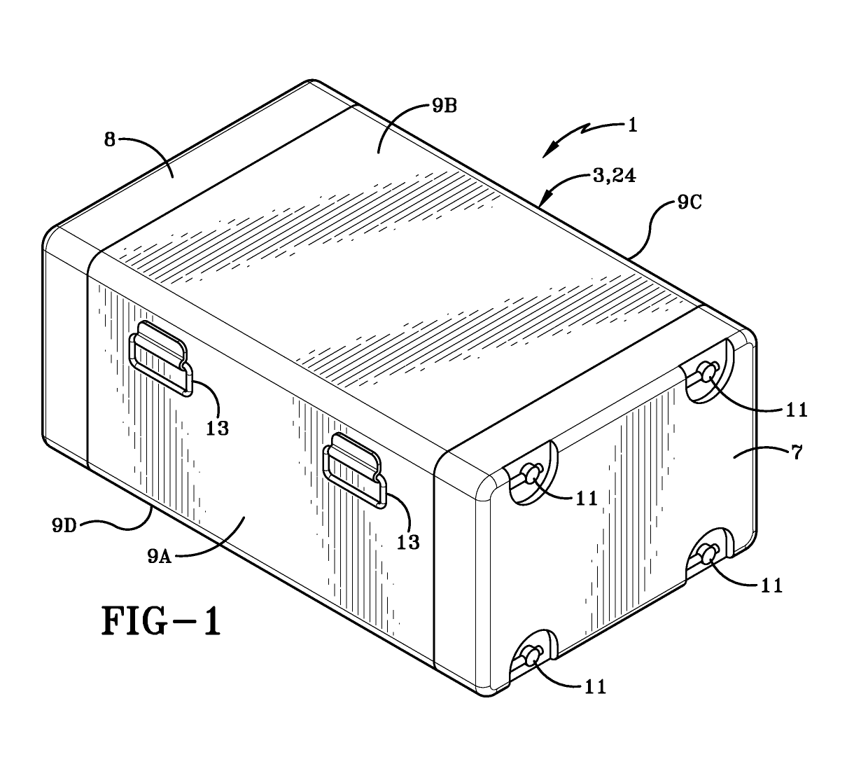

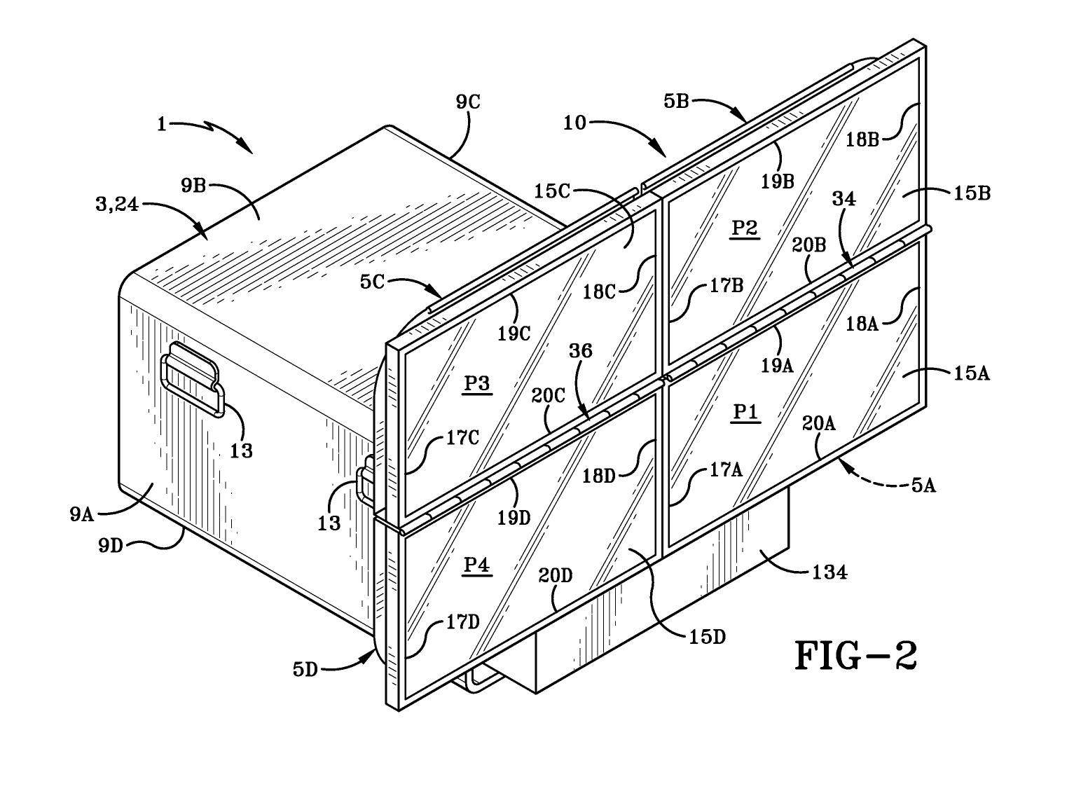

FIG. 1 illustrates a transportable 2×2 monitor device 1 that includes four monitors P1-P4 (not shown; see FIG. 2) that fold up and can be stored in a case 3 via the monitor bracket assembly 10 of the present invention. First, device 1 is described generally; then the components of the monitor bracket assembly 10 described; after that, their use and the way the monitors P1-P4 unfold and are later folded up and are stored in the case 3 will be described.

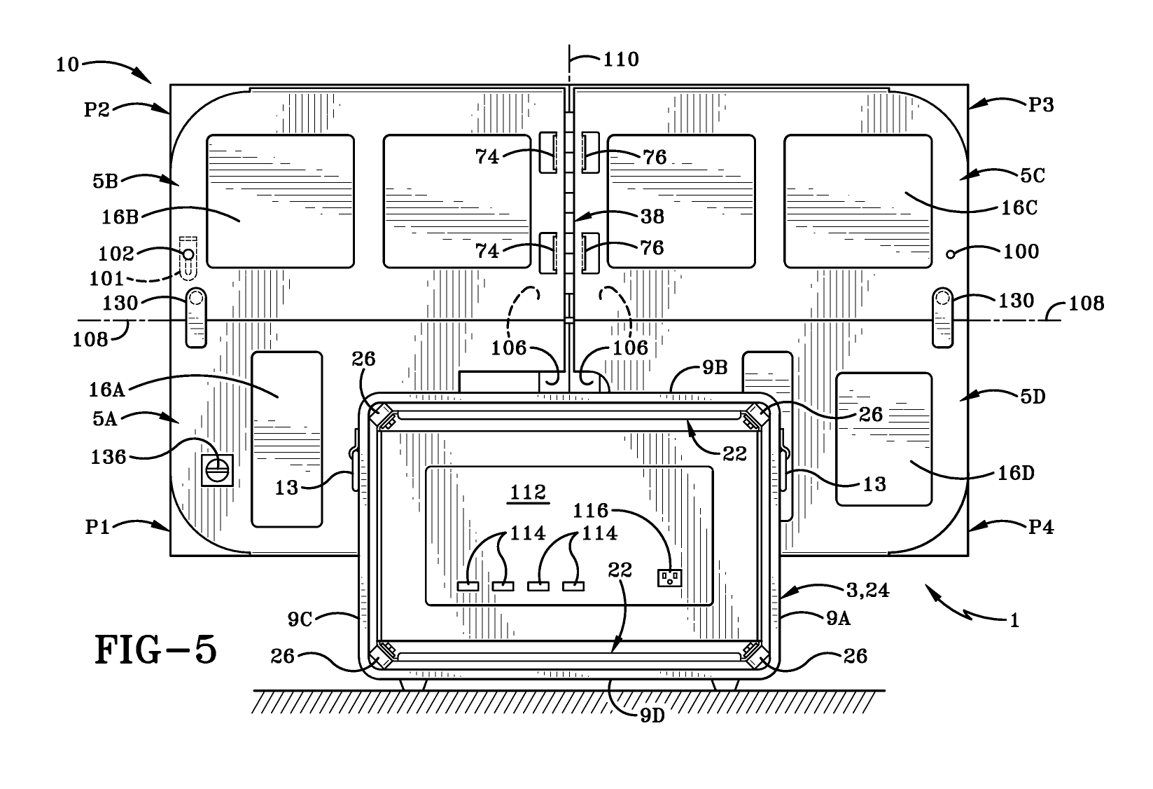

As depicted in FIG. 1 and FIG. 2, the transportable 2×2 monitor device 1 has a monitor bracket assembly 10 mounted therein. The term “2×2” or “2-by-2” refers to four monitors arranged in a grid or array of two columns with two rows each. Device 1 includes the four monitors, namely a first monitor P1, a second monitor P2, a third monitor P3, and a fourth monitor P4 mounted in a monitor bracket assembly 10. Each monitor P1, P2, P3, P4 has a respective front side 15A, 15B, 15C, 15D and a back side 16A, 16B, 160, 16D (FIG. 5) defining a longitudinal direction therebetween; a left side 17A, 17B, 17C, 17D and a right side 18A, 18B, 18C, 18D defining a transverse direction therebetween; and a top side 19A, 19B, 190, 19D and a bottom side 20A, 20B, 20C, 20D defining a vertical direction therebetween. When in the unfolded 2×2 position of FIG. 2, the display assembly 1 has a center of gravity such that the monitors P1-P4 are close enough to the case 3 that the device 1 does not tip over so that no other supports are needed. The case 3 is constructed of rigid material to protect the monitors P1-P4.

The case 3 is rectangular in shape and has a removable front cover 7 and a removable back cover 8 in addition to a left wall 9A, a top wall 9B, a right wall 90 and a bottom wall 9D. The case 3 further includes cover latches 11 to allow the front cover 7 and back cover 8 to be quickly removed from and later locked onto the case 3. These latches 11 can be any suitable latches as understood by those of ordinary skill in this art. The case 3 further includes handles 13 to allow the case 3 to be more easily moved. The total weight of the case is about 150 pounds with about 90 pounds of this weight being the monitors P1-P4 and their monitor frames 5A-5D. The case measurements are about 32 inches long, about 22 inches wide and about 15 inches tall. As discussed later, the monitors P1-P4 fold up and store inside the case in a space that is six rack units (RUs) tall. An inner shell 22 (FIG. 5) of the case 3 is covered by an outer shell 24 that is more weatherproof than the inner shell 22. The case 3 further contains shock absorbing and/or cushioning devices 26 (FIG. 5) between the inner shell 22 and the outer shell 24 and can have other features as understood by those of ordinary skill in the art. In an exemplary embodiment, the case 3 further has an air pressure adjustment device in either its front cover 7 or its back cover 8 or in a wall 9A, 9B, 9C, or 9D that allows the air pressure inside of the case 3 to be adjusted without letting in significant outside impurities. For example, if the monitor assembly is dropped with a parachute, the air pressure adjustment device would change the internal air pressure as the case 3 descends.

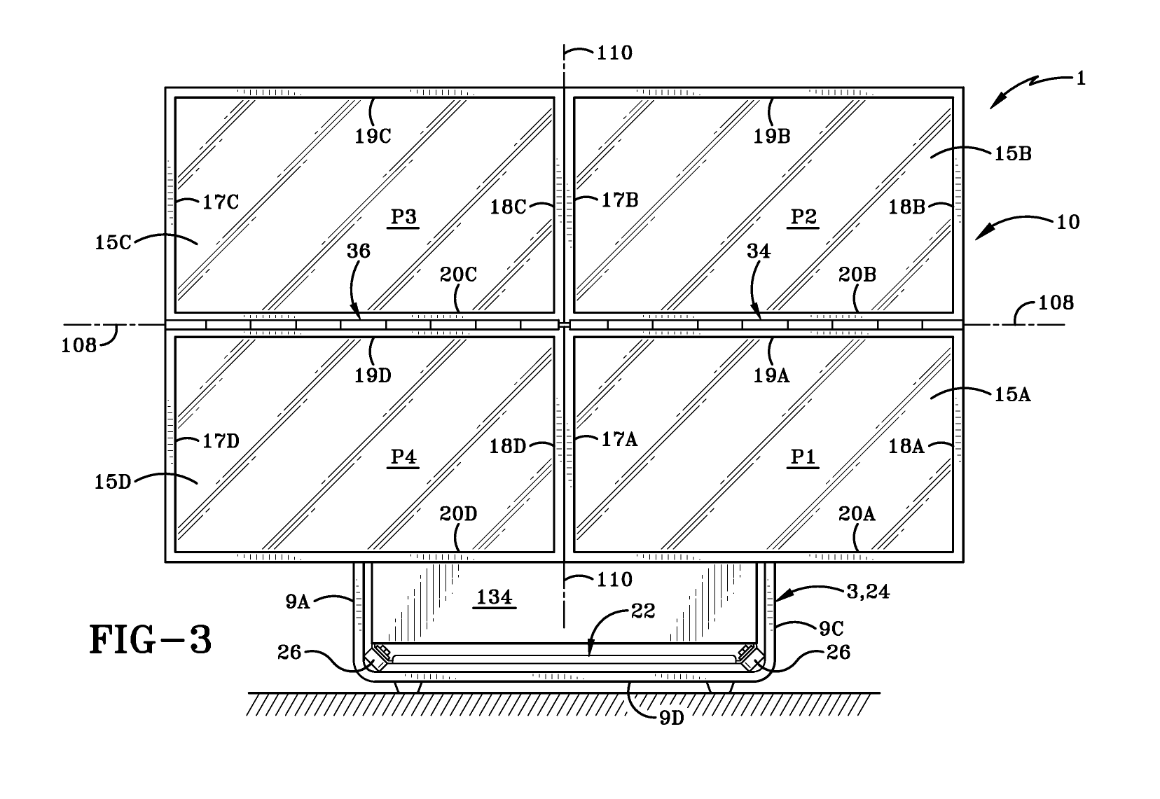

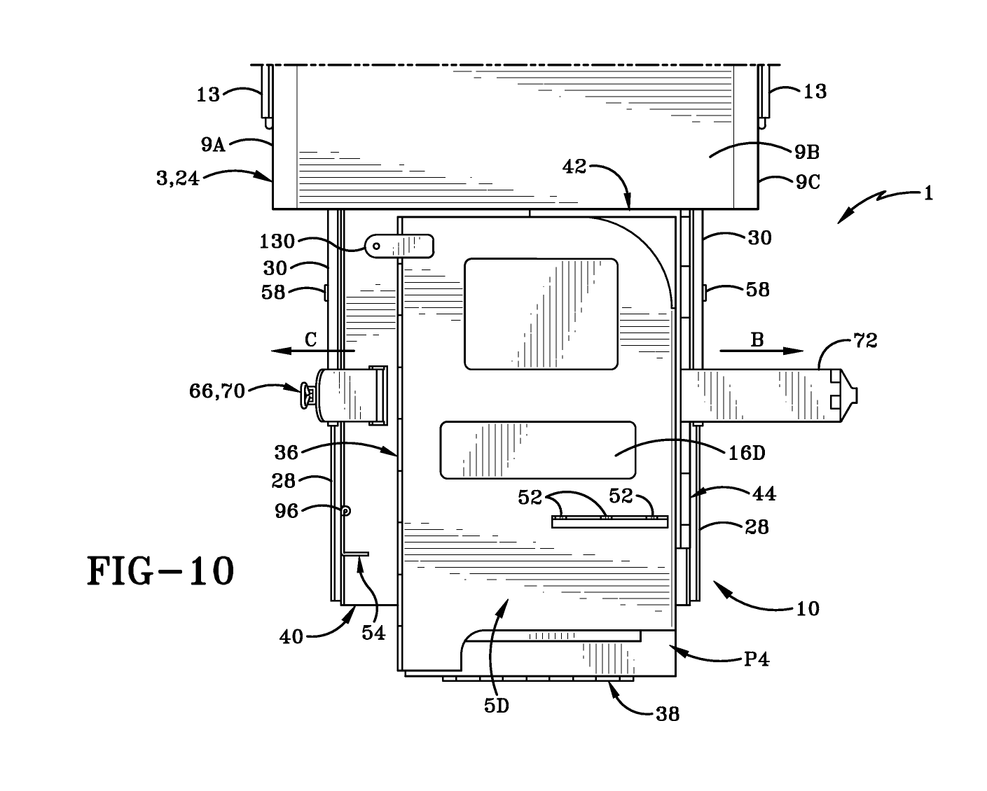

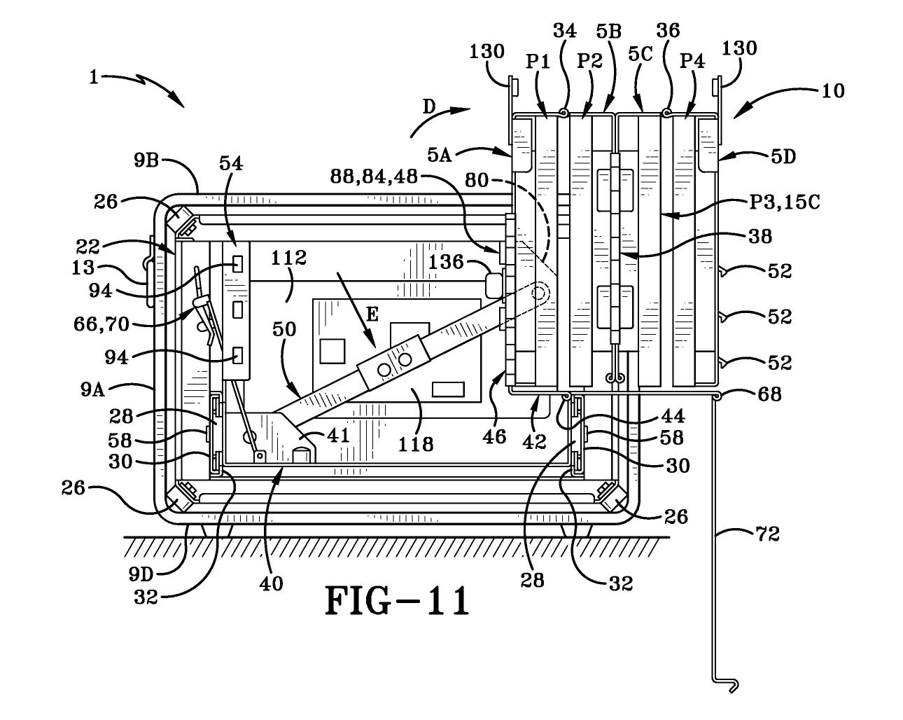

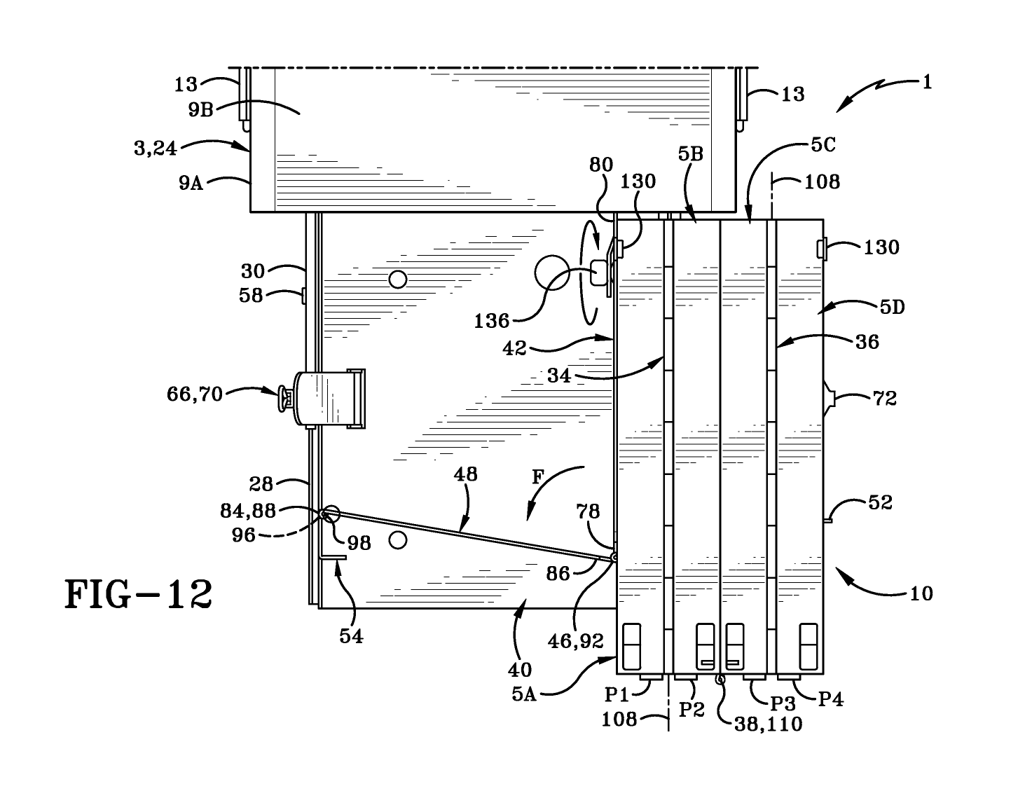

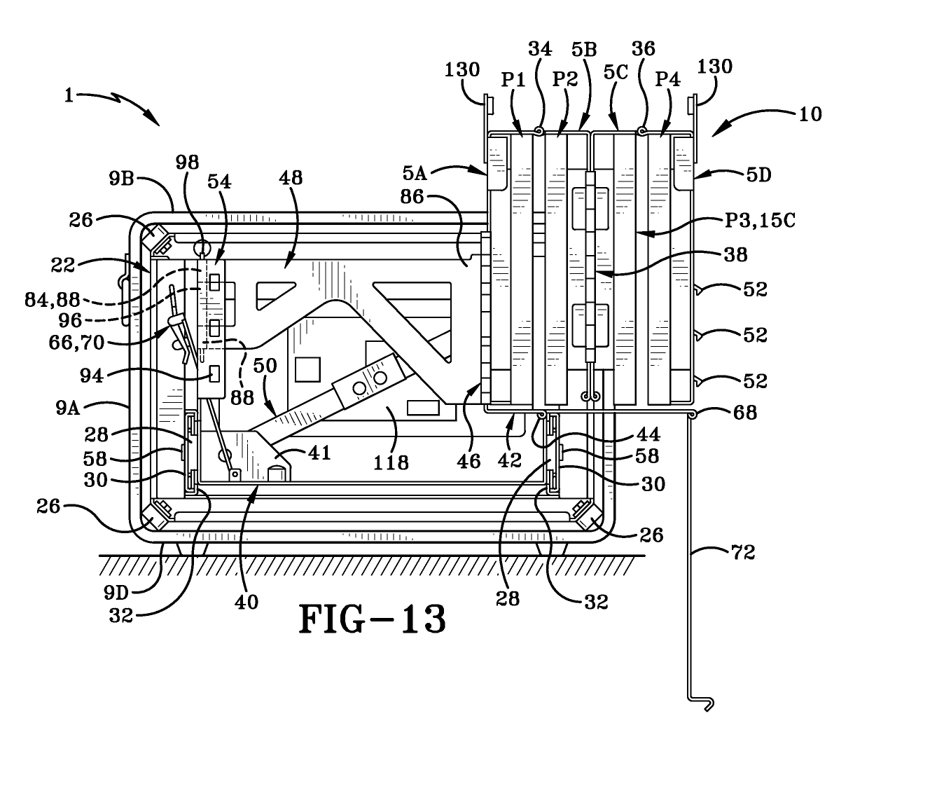

The monitor bracket assembly 10 includes a first monitor frame 5A, a second monitor frame 5B, a third monitor frame 50 and a fourth monitor frame 5D, a pair of main slide rails 28, a pair of intermediate slide rails 30 and a pair of outer side rails 32. The monitor bracket assembly 10 may further comprise a generally transverse frame first hinge 34 (FIG. 3), a generally transverse frame second hinge 36 (FIG. 3), a generally vertical frame third hinge 38 (FIG. 5), a tray 40 (FIG. 10), a monitor group support plate 42 (FIG. 12), a generally longitudinal monitor group first hinge 44 (FIG. 11), a generally vertical monitor group second hinge 46 (FIG. 11), a collapsible K-bracket 48 (FIG. 13), a rear monitor support arm 50 (FIG. 11), a support tab 52 (FIG. 11), and a support post 54 (FIG. 11).

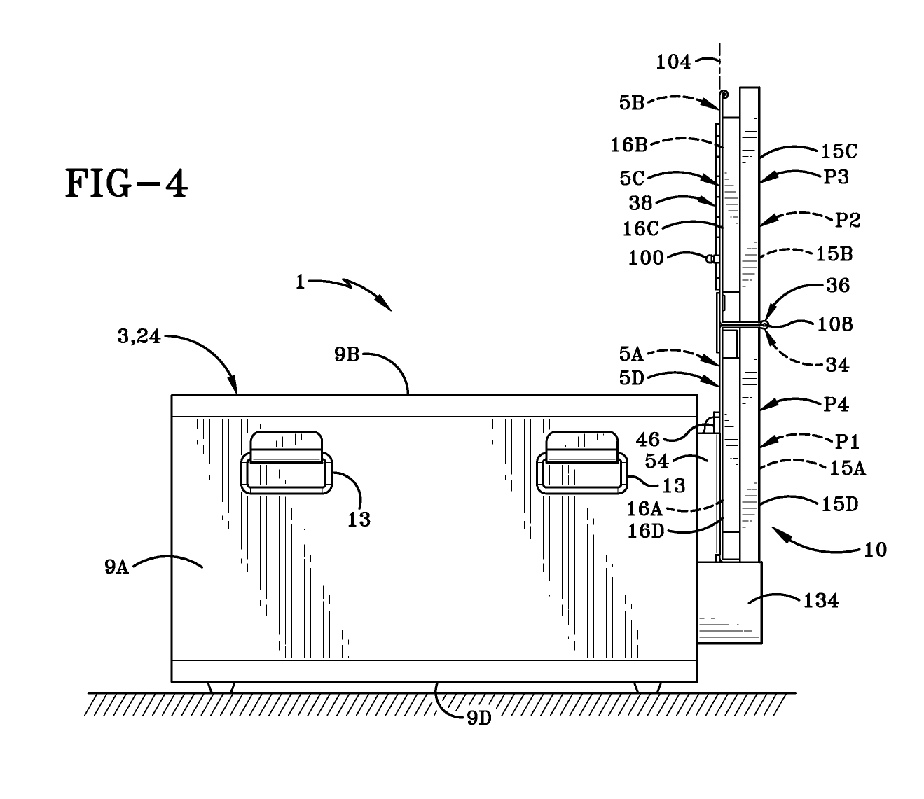

Frames 5A, 5B, 5C, 5D can be unfolded (via hinges, detailed below) and positioned adjacent each other in a 2×2 grid formation in a single transversely extending plane 104, to the deployed 2×2 second position depicted in FIG. 2, FIG. 3, and FIG. 4.

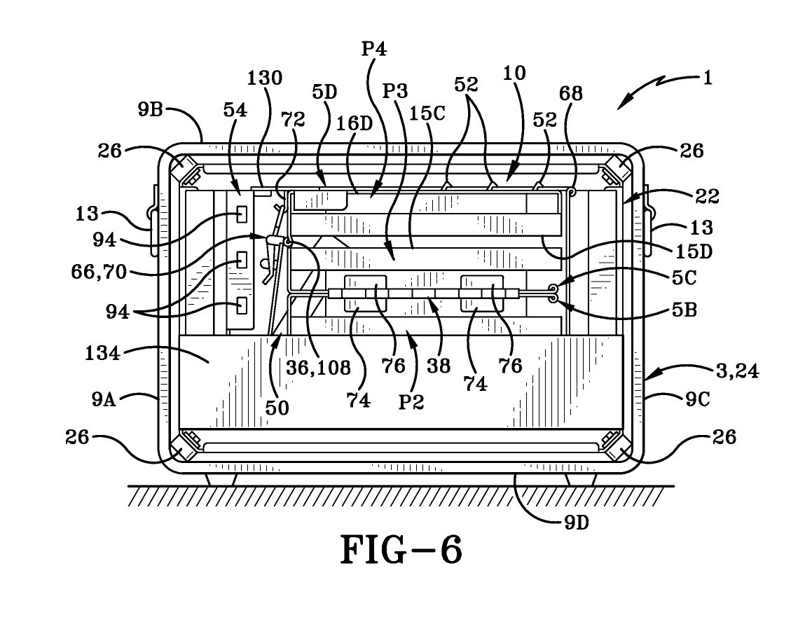

As depicted in FIG. 6, monitor bracket assembly 10 is covered by a shroud 134 when monitor bracket assembly 10 is in the stored position within case 3. Shroud 134 is a rigid member extending transversely from left side of case to right side of case 3. Shroud 134 includes a releasable attachment, such as a magnet, in order to aesthetically cover portions of the cavity within case when in use. Shroud 134, preferably magnetically, attaches to inner shell 22 adjacent the forward end of the case. Shroud 134 is depicted in FIG. 6 adjacent the bottom of the case, however other positions are entirely possible, such as near the top or near the middle of the case when viewed from the front. Shroud 134 is removed in order to begin the process of unfolding monitor bracket assembly 10 but may be reattached, as depicted in FIG. 3, when monitor bracket assembly 10 has been unfolded into the 2×2 second position (FIG. 3).

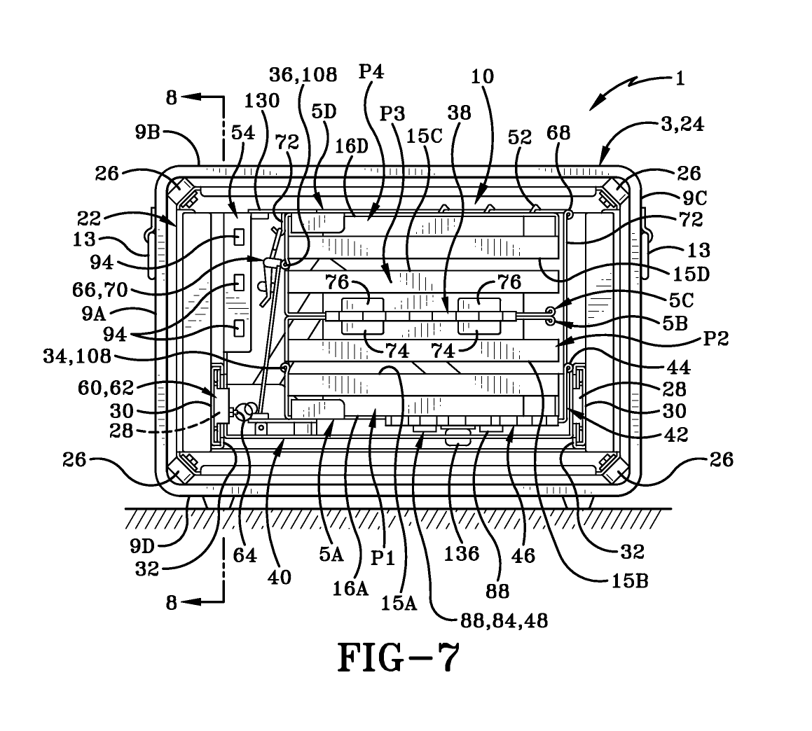

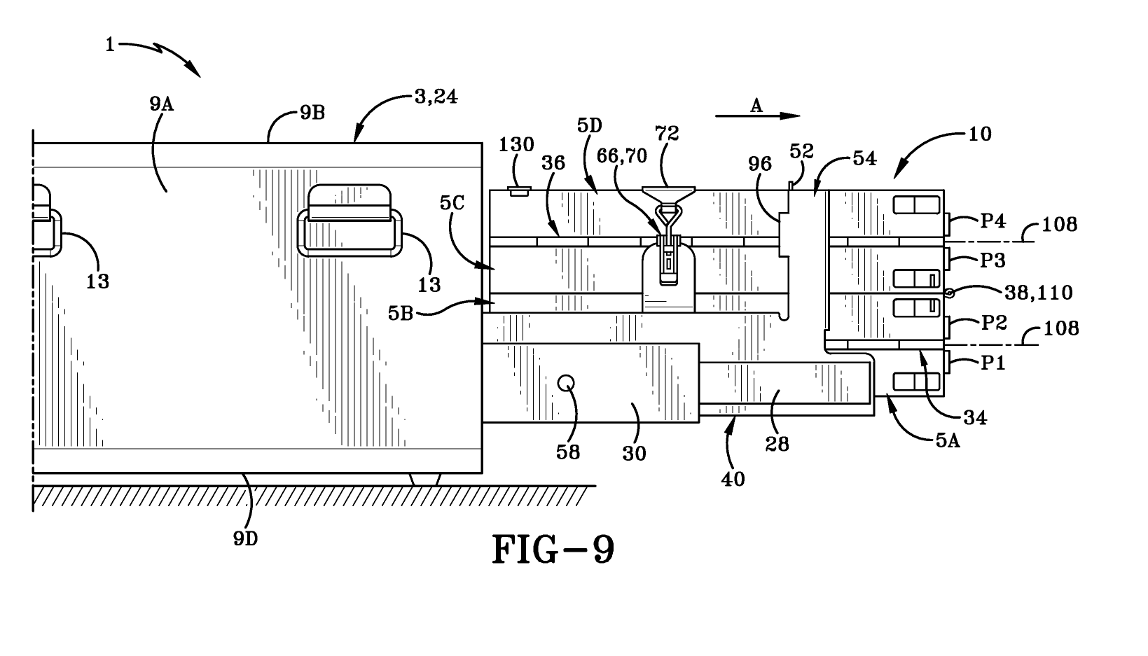

As depicted in FIG. 7 and FIG. 9, a compression lock mechanism 66 prevents vertical and transverse movement of the monitor frames in the stored position within the case. The compression lock 66 extends upwardly from pivot connection at hinge 44 to form another pivot connection 68 relative the tray 40 and main slides 28 and extends upwardly and around the perimeter of folded group of monitors. The compression lock 66 includes a lock 70 adjacent the left side of the main slide that releasably secures compression lock strap 72 around the folded group of monitors to secure the monitor frames 5A-5D to the tray 40 and rails 28. Compression lock 66 may include an adjustable member, such as a threaded screw, to allow slight variations of compression as one having ordinary skill would understand (See FIG. 9).

A first finger flange 74 is on the second monitor frame 5B and a second finger flange 76 is on the third monitor frame 5C. The finger flanges 74, 76 are adapted to allow a user to slide the monitor outwardly from the stored positon in the case 3 by pulling on the flinger flanges 74, 76.

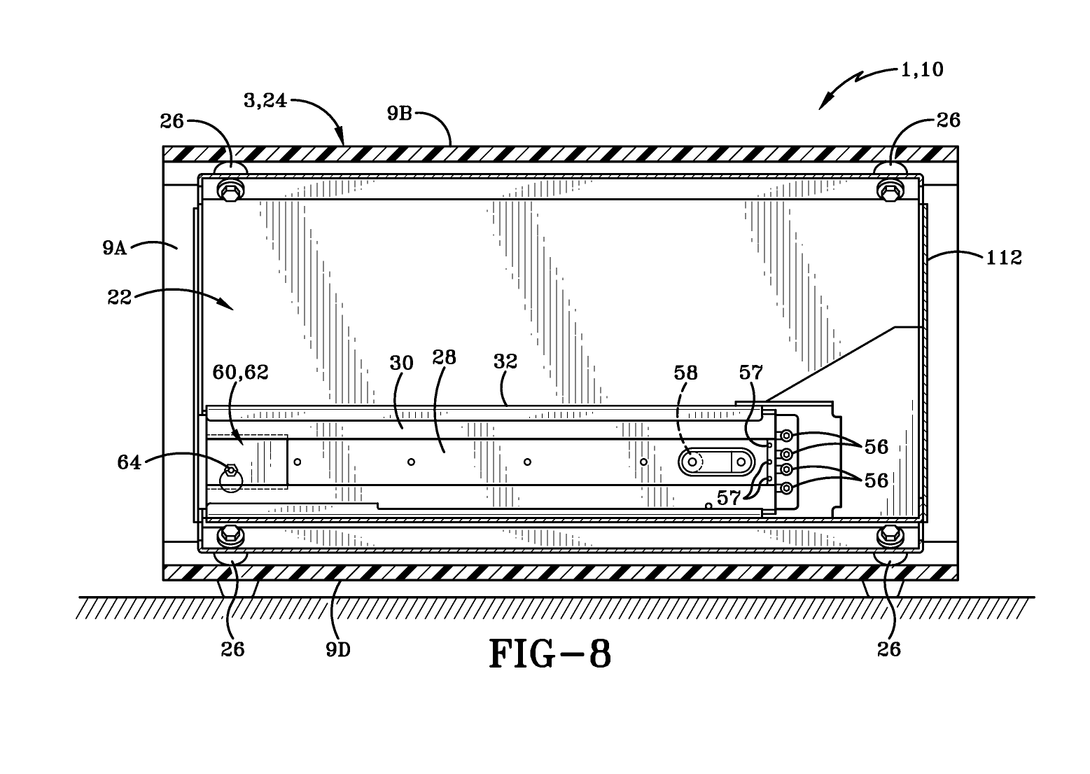

With primary reference to FIG. 8, the pair of outer side rails 32 are respectively mounted to left and right walls in inner shell 22 of case 3. Outer slide rails 32 are rigid members that are rigidly affixed to the inside shell 22 of case 3 preferably adjacent the left and right walls 9A and 9C. The outer side rails 32 extend longitudinally from front to back relative to the case 3. A rear end of rail 32 is spaced closely adjacent rear cover 8 of case 3. A forward end of outer side rail 32 is closely adjacent front cover 7 on case 3. Similarly, a right outer rail extends longitudinally substantially parallel to a left outer rail including a forward end spaced opposite a rear end. A set of rear stop members 56 extend through each of the outer rails 32 adjacent the respective rear ends. The stop members 56 prevent the intermediate side rails 34 or the main side rails 28 from longitudinally extending too far in the rear direction. The stop members 56 act as a preventative locking mechanism limiting longitudinal movement when the monitor frames are stored and folded in the second position. In the shown embodiment the stop members 56 are enlarged screw heads, but others stop members are entirely possible. Intermediate slide rails 30 are slidably received and coupled to outer slide rails 32. Intermediate slide rails 30 slide within a channel defined in outer slide rails 32. Stop pins 57 may extend from a rear end of intermediate slide 30 to stop main slide 28. Intermediate slide rails 30 are rigid members. A slide detent 58 (e.g., button) is located on the intermediate slide 30 and is configured to lock the intermediate slide 30 to the outer slide 32. The main slide rails are rigid members slidably received in a channel of the intermediate slide rails 30. Together the three pairs of slide rails 28, 30, 32 cooperate in a longitudinally telescoping arrangement to allow the main slide rails 28 to slide out of the case to which various components of the monitor bracket assembly 10 are also attached.

A longitudinal forward slide block lock 60 is positioned adjacent the forward end of main slide rails 28 to prevent longitudinal movement of slides 28, 30, 32 when stored in the folded position. Slide lock block 60 includes a block member 62 shaped complimentary to fit within one of the slide channels and includes an aperture extending through the block member allowing a pin lock 64 to attach block member 62 to the intermediate slide 30. Together, the rear stop members 56, pin stops 57, and lock block 60 limit longitudinal movement of monitor frames 5A-5D stored within the box.

As depicted in FIG. 10, the tray 40 extends transversely from a fixed connection with each of the main slide rails 28. The tray 40 is a generally rectangular rigid member defining a region thereabove of which the monitor frames 5A-5D are stored in the folded position. The tray 40 slides in unison with the main slide rails 28.

As depicted in FIG. 11, the monitor group support plate 42 is a rigid member coupled to the tray 40 via a generally longitudinal monitor group first hinge 44. Monitor group first hinge 44 permits the group support plate 42 to rotate about a longitudinal axis relative to the tray 40 adjacent the pair of main slide rails 28. Hinge 44 may be between the pair of rails 28. The monitor group support plate 42 includes a forward end 78 spaced opposite a rear end 80. The collapsible bracket 48, which is a K-bracket including two legs and defining cut-out areas, is coupled via hinge 46 adjacent the forward end 78 of the monitor group support plate 42. The four monitor frames 5A-5D are coupled to the monitor group support plate 42.

As depicted in FIG. 12 and FIG. 13, the collapsible K-bracket 48 includes a first end 84 spaced opposite a second end 86. First end 84 of K-bracket 48 includes a barrel 88 and second end 86 includes a spring member 92. Spring member 92 attaches a spring to hinge 46 coupling K-bracket 48 to monitor support group plate 42. Further, while the bracket 48 is identified as a K-bracket, any shaped bracket could be substituted that supports plate 42.

The support post 54 extends upwardly from a rigid connection with a forward end of the main slide 28. The support post 54 includes a longitudinally forward facing first surface spaced opposite a rear facing second surface. Support post defines a plurality of slots 94 or apertures extending longitudinally from first surface to second surface. A barrel 96 is attached to support post 54. Barrel 96 on support post 54 is complimentary to the barrel 88 on K-bracket 48.

K-bracket 48 may be forcibly biased against the spring 92 resistance such that after monitor group support plate 42 has been rotated upwards, about the longitudinal hinge 44, K-bracket 48 may be swung out to align the barrel 88 on K-bracket 48 with the barrel 96 on support post 54. A purposeful misalignment occurs when K-bracket 48 is swung out requiring a user to manually lift the K-bracket 48 over a portion of barrel in order to align a pin 98. Inserting pin 98 through the aligned barrels 88, 98 aligns monitor support group plate 42 at 90° relative to horizontal. This forceful alignment ensures the stability of monitor bracket assembly 10.

The K-bracket 48 is disposed between the monitor group support plate 42 and the tray 40 in the collapsed position. The K-bracket extends transversely between the pair of main slide rails 28 supporting the monitor group support plate 42 in the extended position and extends longitudinally parallel to the main slide rails 28 in the collapsed position.

Adjacent the rear end 80 of monitor group support plate 42 the moveable support arm 50 is a rigid member and extends from one side (here, the left side) slide rails transversely relative to the rear end of the tray 40. One end of support arm 50 pivotably attached to plate 41 which extends upward from a rear end of tray 40. Another end of the rear monitor support arm 50 connected adjacent the rear second end 80 on the monitor group support plate 42 and extending transversely between the pair of main slide rails 28 supporting the monitor group support plate 42 in the extended position longitudinally rearward from the K-bracket 48. Support arm 50 provides support of monitor bracket assembly 10 in the extended position. Support arm 50 is collapsably extendable with the support plate 42 and may be folded away when not in use.

The generally vertical monitor group second hinge 46 is located near the forward end 78 of monitor group support plate 42. Vertical second hinge 46 is coupled to frame 5A, allowing frames 5A, 5B, 5C, and 5D to rotate about a vertical axis.

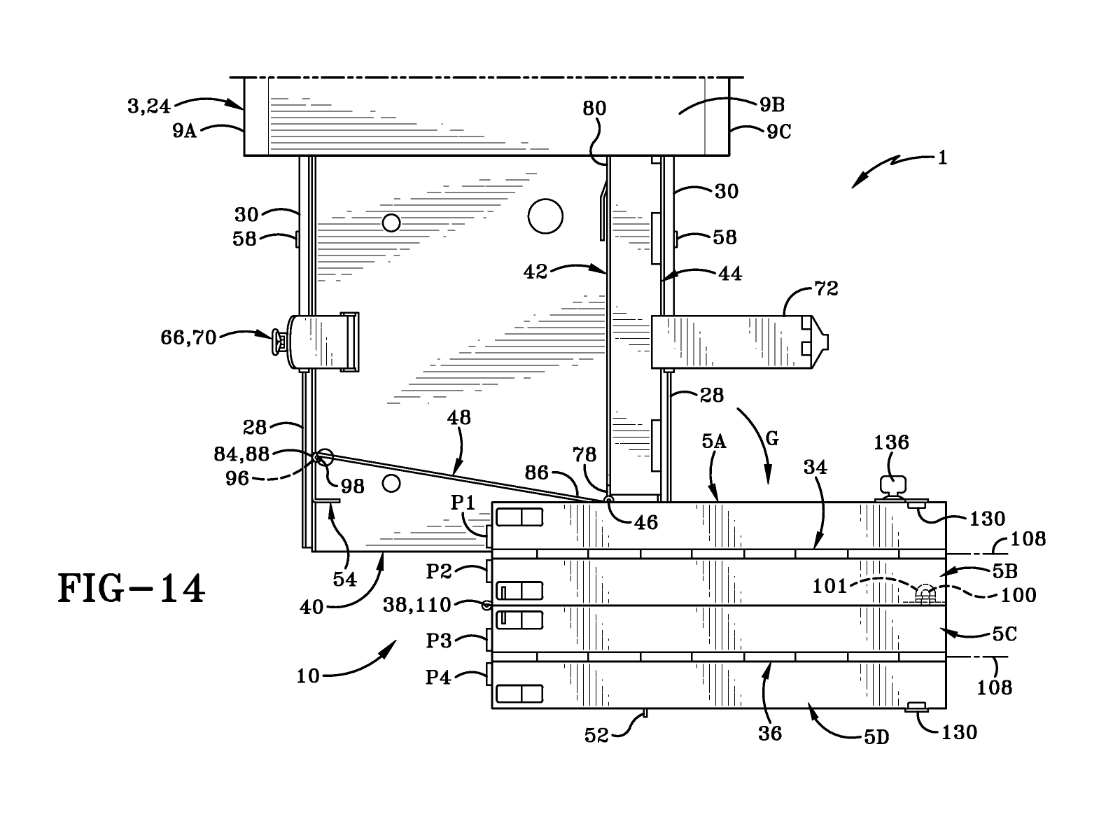

A latch 136 (FIG. 12) extends from group of four monitor frames through an aperture formed adjacent second end 80 of plate 42. Latch 136 is twistable in a manner allowing latch 136 to pass through plate 42 to release the group of monitor frames 5A, 5B, 5C, 5D such that they may rotate around vertical hinge 46 in the direction indicated in FIG. 14.

A lock including pin 100 (FIG. 5 and FIG. 14) on third frame 5C extends through a receiving aperture 102 in second frame 5B locking the group of monitors together via slide 101. When unlocked, the frames 5C and 5D may be unfolded around the third monitor frame hinge 38.

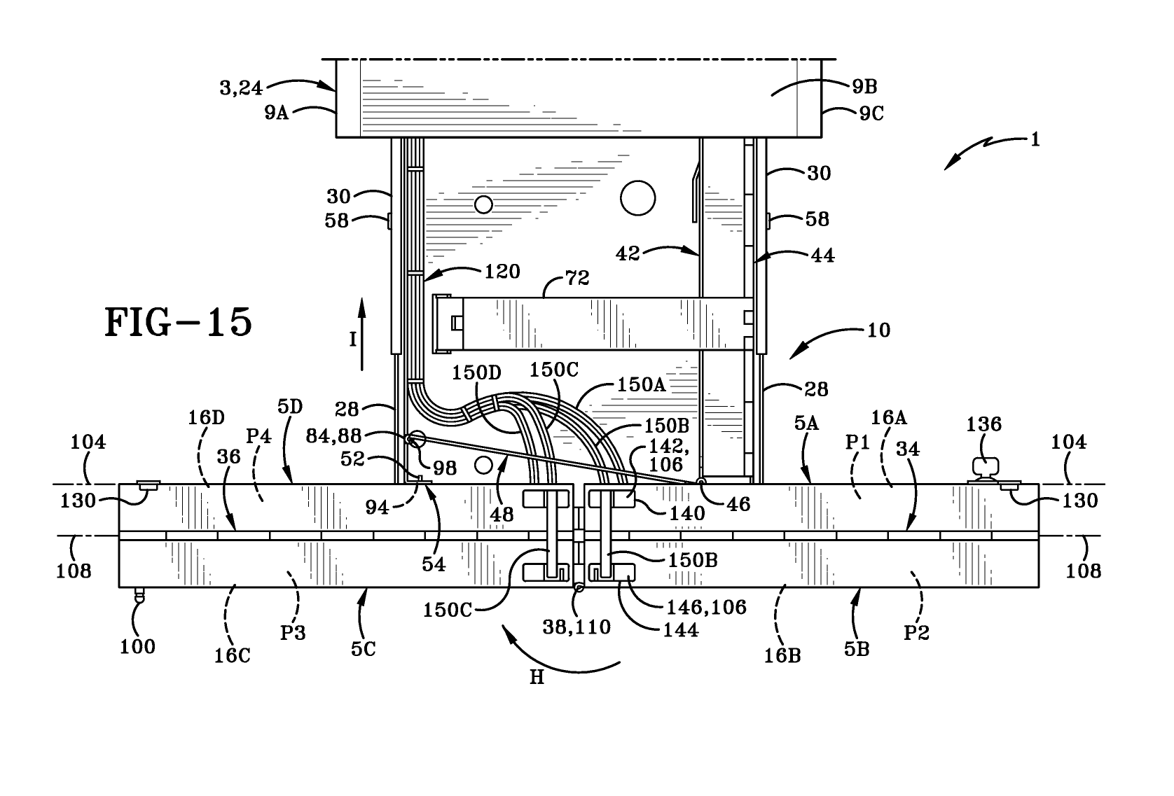

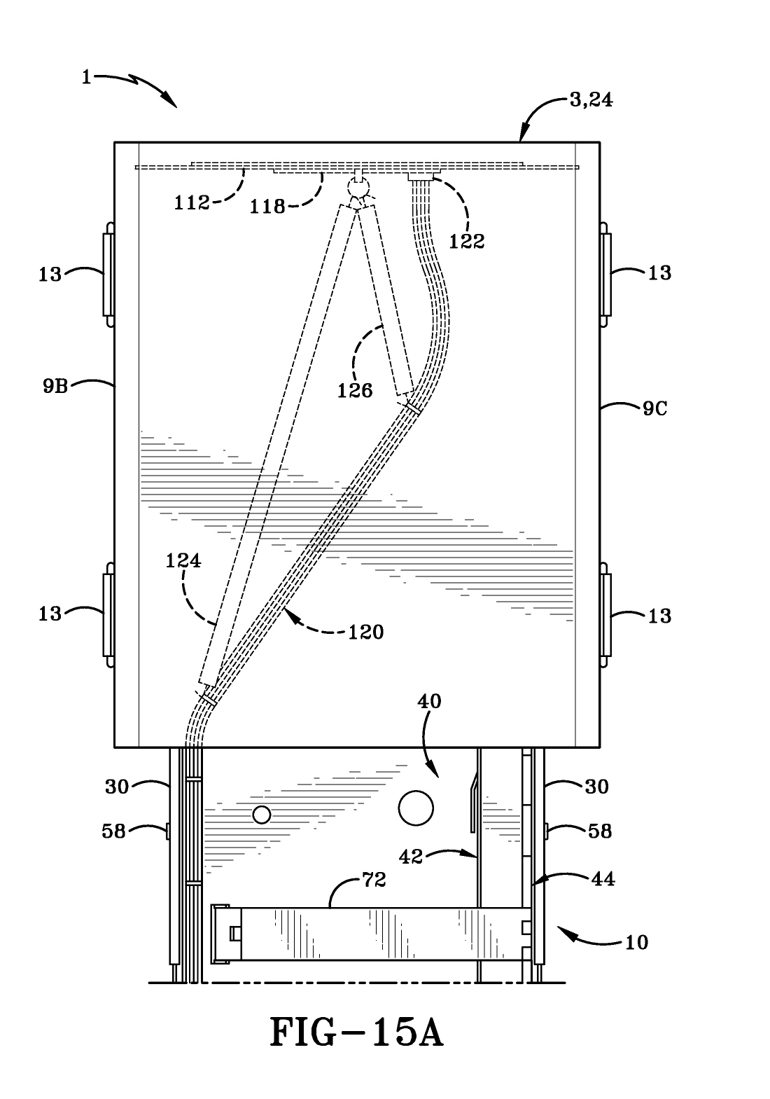

Turning to FIG. 15, the monitor frames 5A-5D are generally rectangular in shape, made of rigid metal and are used to support the monitors P1-P4 as well as their wiring. Each frame 5A, 5B, 5C, 5D defines a hollow passageway or electrical raceway 106 therein configured to allow wiring for the respective monitors to pass therethrough. A rounded first edge 140 forms a first aperture 142 in the first monitor frame 5A providing access to the electrical raceway 106. A rounded second edge 144 for forms a second aperture 146 in the second monitor frame 5B providing access to the electrical raceway 106, wherein the first and second apertures 142, 146 vertically align when the four monitor frames 5A-5D are in the unfolded second position.

Monitor bracket assembly 10 includes the generally transverse frame first hinge 34 pivotably coupling the first monitor frame 5A to the second monitor frame 5B permitting rotation about a transverse axis 108. The generally transverse frame second hinge 36 pivotably coupling the third monitor frame 5C to the fourth monitor frame 5D permitting rotation about the transverse axis 108. The generally vertical frame third hinge pivotably coupling the second monitor frame 5B to the third monitor frame 5C permitting rotation about a vertical axis 110.

Briefly turning back to FIG. 5, an illustration of a rear view of the case 3 with the back cover 8 removed is provided. A panel 112 is illustrated mounted within the case 3. Four video connectors 114 are mounted horizontally on the panel 112 along with a power receptacle 116. These connectors 114 can be video graphics array (VGA), DVI, HDMI, or another kind of video connector as understood by those of ordinary skill in the art. One aspect, a printed circuit board (PCB) 118 is mounted on the inside face of the panel 112 to transform the power supply for monitors P1-P4.

As depicted in FIG. 15 and FIG. 15A, the wiring 120 of the monitors P1-P4 is routed along monitor bracket assembly 10 to allow the monitors P1-P4 to be very quickly unfolded into a 2×2 arrangement and then later refolded and stored back inside the case 3. The wiring 120 originates as a single main bundle of wires 122 generally extending from the PCB 118 on the rear panel 112. This main bundle 122 includes wires carrying video image data as well as power for the monitors P1-P4. A first spring 124 and a second spring 126 are attached to the main bundle of wires 122 and attached to the top of rear panel 112. Alternatively first spring 124 and a second spring 126 may be attached to the top wall of the inside shell 22 of the case 3, so long as the rear ends of spring 124 and 126 are longitudinally rearward of their connection with main bundle 122. These spring(s) 124, 126 act to pull the main bundle of wires 120 leftward and upward out of the way of a central compartment where the monitors P1-P4 are stored.

When the monitors P1-P4 are pulled from the case and frames 5C, 5D are unfolded from frames 5A, 5B, the main bundle of wires 120 extends to a central recessed area formed by monitor frames 5A and 5D. At this recessed area the main bundle of wires 120 splits into a P1 bundle of wires 150A, a P2 bundle of wires 150B, a P3 bundle of wires 150C and a P4 bundle of wires 150D. The P1 bundle of wires 150A enters a lower left opening formed in the lower right side of monitor frame 5A of monitor P1 (when viewed from the back side as viewed in FIG. 5) and then proceeds to monitor P1. Similarly, the P4 bundle of wires 150D enters a lower left opening formed in the lower left side of monitor frame 5D of monitor P4 (when viewed from the back side as viewed in FIG. 5) and then proceeds to monitor P4.

The P2 bundle of wires 33 extends upward and passes through rounded apertures 142, 146 near the upper right corner (when viewed from the back side as viewed in FIG. 5) of monitor frame 5A of monitor P1. Similarly, the P3 bundle of wires 150C extends upward and passes through an apertures shaped and postponed similarly to 142, 146 near the upper left corner (when viewed from the back side as viewed in FIG. 5) of monitor frame 5D of monitor P4. Each bundle 150B, 150C respectively passes through these apertures. After passing through aperture, the P2 bundle of wires 150B passes downward through the aperture near the upper right corner (when viewed from the back side as viewed in FIG. 5) of monitor frame 5B of monitor P2. Similarly, after passing through an aperture, the P3 bundle of wires 150C passes through an opening near the upper left corner (when viewed from the back side as viewed in FIG. 5) of monitor frame 5C of monitor P3. These two bundles 150B, 150C then continue on to monitors P2 and P3, respectively. A vertical locking device 130 that locks the monitor frame 5C to frame 5D. As illustrated in more detail in FIG. 9, the vertical locking device 130 includes three locking tabs 52 that when in the locked position pass through slots 94 in the vertical support post 54 to lock monitor frame 5D to the vertical support post 54.

Having described the components of the device 1, its use and operation are now described. Initially, the device 1 will have its front cover 7 and rear cover 8 attached to the case 3 when it is transported to a location where it is to operate. For example, it can be transported to a field on a vehicle or it can be parachuted to a location with a parachute. Once at the desired location it can further be positioned by lifting it with the handles 13. Once at the desired location, the front cover 7 is removed as well as the rear cover. These covers 7, 8 can be removed once their cover latches 11 have been opened. Sources of video content for each of the displays P1-P4 are then plugged into their respective video connectors 114 and a power cable can be plugged into the power receptacle 116. The connections preferably made after the displays P1-P4 of the display device 1 are unfolded into their operating position as described next.

After the front cover 7 is removed the four displays P1-P4 together with their monitor frames 5A-5D can be slid out as one unit as intermediate slide 30 and the outer slide 32 are extended from the main slide 28. As illustrated in FIG. 9, the displays P1-P4 together with their monitor frames 5A-5D slide out in the direction of arrow A until the slide detent 58 (e.g., button) of the main side 28 snaps into an opening on the intermediate slide 30 locking the slides in an extended position. Compression lock 60 is unlocked and strap 72 is pulled transversely outward in the direction of arrow B. Lock 70 is pulled and rotated away from tray in a direction along arrow C (which is opposite to arrow B). Next, the folded group displays P1-P4 and their monitor frames 5A-5D are rotated in the direction of arrow D, as shown in FIG. 11, about horizontal hinge 44 until they have been rotated 90 degrees and they are locked into this position by placing the rear arm 50 into the position illustrated by arrow E. K-bracket 48 is locked into place by swinging it about hinge 46 in the direction of arrow F. Pin 98 pivotably couples barrel 88 and barrel 96 together. Next, the monitor group latch 136 of FIG. 12 is unlatched. This allows the folded group of displays P1-P4 and their monitor frames 5A-5D to now be rotated 90 degrees about the vertical hinge 46 in the direction of arrow G as best seen in FIG. 14. After this rotation, the slide detent 58 (e.g., push button lock) is pushed unlocking the intermediate slide 30 and the main slide 28. This allows for the pushing of the unfolded group displays P1-P4 and their monitor mounts 5A-5D toward the case 3 in the direction of arrow I as seen in FIG. 14 and FIG. 15. This at least partially retracts the intermediate slide 38 and the outer slide 28 into the outer slide 32.

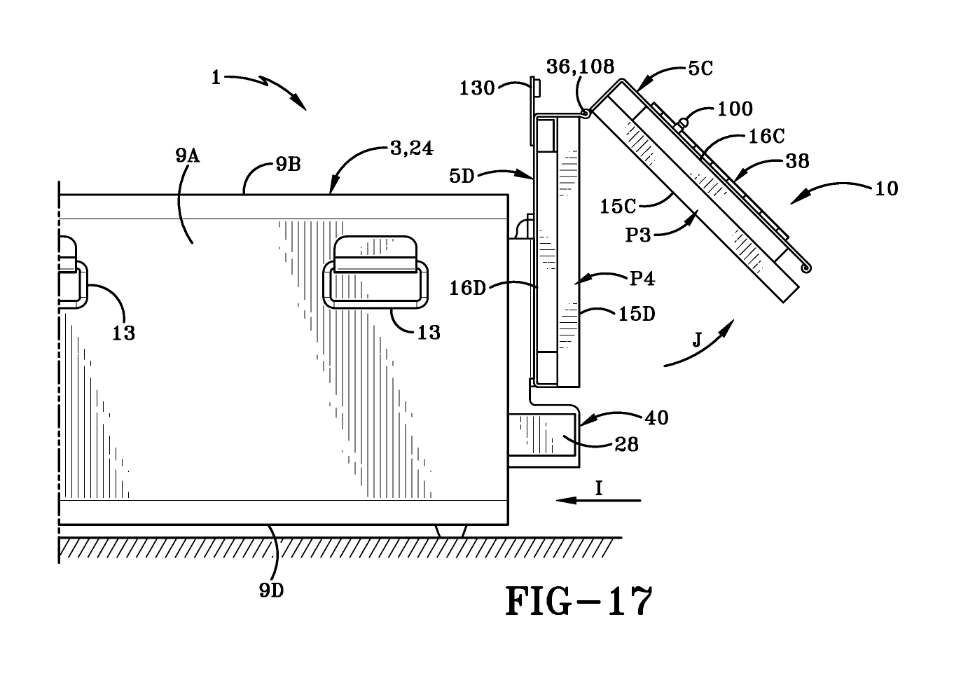

Now the unfolding of the group of displays P1-P4 and their monitor frames 5A-5D begins. As illustrated in FIG. 15, the P3 and P4 monitors, together with their monitor frames 5C, 5D are unlocked via 100, 102, and are rotated 180 degrees about the third hinge 30 in the direction of arrow J. When these monitors have been nearly rotated 180 degrees, the vertical locking device 52 for tabs on the back side of monitor frame 5D will approach complementary slots 94 on the vertical support post 54 until they pass through those openings 92 and lock monitor frame 5D and display P4 in place as best seen in FIG. 15. Notice that up until this step there has not been any need for a person to physically manipulate the main bundle of cables 120 nor the cables 150A, 150B, 150C, and 150D. This is because the free space inside the left portion of the case 3 allows these cables to be easy extracted along with the folded group of displays P1-P4 and their monitor frames 5A-5D. Lastly, as shown in FIG. 17 monitors P2-P3 together with their monitor frames 5B-5C are rotated 180 degrees upward in the direction of arrow J until the vertical monitor latches 130 click into place with complementary openings on monitor frames 5B and 5C. During this step some manual manipulation of the P2 bundle of wires 150B at opening 142, 146 and the P3 bundle of wires 150C at opening may be required to be sure these wires enter these openings. The device 1 is then in the unfolded 2×2 position as shown in FIG. 2. Then, once device 1 is in the unfold 2×2 position, the slides 28, 30 may be pushed back into the case to create a vertical and transverse alignment of the monitors in a single plane. The shroud 134 may then be reattached to aesthetically cover a lower portion of device 1.

Once external video cables have been connected to the device 1 via 114, the display device 1 is ready for operation. In operation, a single image can be displayed continuously across all four monitors P1-P4. Alternatively, the display assembly 1 can be configured to display one image across two of the monitors and a different image across the other monitor. Single different images can be displayed in any one of the monitors. Of course, any number of the monitors can display a first image and any number of the monitors can display a second different image.

Returning the monitors P1-P4 into the case 3 happen in an exact reverse direction of what was described above. First, P2 and P3 monitors are rotated downward 180 degrees until they are adjacent monitors P1 and P4. Next, the slides 28, 30, 32 are extracted until the slide detent (e.g., button lock) is activated. Then, the teeth or tabs 52 of the vertical locking devices are elevated to release their connection with support post 54. Next, monitors P3 and P4 are rotated 180 degrees via hinge 38 about axis 110 until monitor P3 is adjacent monitor P2. Next, monitors are rotated 90 degrees about the vertical hinge 46. Next the rear latch arm 50 is folded to allow the folded monitors to be rotated 90 degrees about the horizontal hinge 44. Finally, the slide detent 58 (e.g., button lock) is pressed to unlock the slides 28, 30 and 32 so that the monitors can be pushed back into the case 3. The springs 124, 126 pull the main bundle of wires 120 upward and leftward out of the way of the monitors being returned to the case 3. There may be some minimal physical handling of wiring as the monitors are slid into the case 3. Then the block lock 60 is locked, and the compression lock 66 is locked.

Additionally, the 2×2 monitors P1-P4 could also be connected in rows and stacked for larger scaling applications with additional devices 1 to create a larger viewing screen, such as a 4×4 viewing area.

An additional aspect of the present invention includes the method of affecting a user or instructing a user to unfold the monitor frames as detailed above. The method comprises the steps of providing a monitor bracket assembly 10 mounted in a case 3 to a user, wherein the bracket assembly 10 is configured to move between a folded and stored first position to an unfolded 2×2 second position. Then, affecting the user to longitudinally draw a monitor frame on the bracket assembly in a stored position outwardly from the case. The step of affecting the user to longitudinally draw a monitor frame on the bracket assembly in a stored position outwardly from the case may be accomplished by providing a set of instructions to the end user including a set of pictures or schematic representations. Then, affecting the user to pivot the monitor frame about a hinge to deploy the frame associated with the unfolded 2×2 position. The step of affecting the user to pivot the monitor frame about a hinge to deploy the frame associated with the unfolded 2×2 position may be accomplished by providing a set of instructions to the end user.

An exemplary set of instructions associated with the above described method of affecting a user may include the non-limiting and exemplary instructive steps of:

STEP 1: Place transit case 3 with 2×2 Monitor Drawer Assembly (MDS) or assembly 10 on a sturdy, flat surface.

STEP 2: Remove end caps 7, 8 from the transit case 3. End caps 7, 8 are not required for 2×2 MDS assembly 10 deployment or final position.

STEP 3: Remove shroud from front of 4 monitor stack to allow deployment of MDS assembly 10. Shroud 134 will be re-attached (magnetized) in Step 19 once the 2×2 MDS assembly 10 is fully deployed.

STEP 4: In lower left corner of transit case, remove tethered transit stop-block 60 by puffing spring loaded detent pin 64 out and sliding transit stop-block forward and out. Hang tethered transit stop-block on eye hook in top left corner of transit case.

STEP 5: Utilizing finger tabs 74, 76 located between top and bottom stacked monitors, pull drawer out fully until final slide detents 58 are engaged. There should be two sets of clicking sounds indicating full extension of the drawer.

STEP 6: Remove tethered transit compression latch lock 66 pin from left side of the monitor stack. Pull towards transit case and lay latch pin down in the left bottom side of the drawer.

STEP 7: Lift and release transit compression latch strap 72. Lift and rotate transit compression hinged bracket strap 72 across monitors and allow to hang or lay freely via pivot connection 68.

STEP 8: Rotate 4 monitor stack upwards 90 degrees to vertical position.

STEP 9: At the back of the drawer, lock rear monitor support arm 50 by pressing downward on the support arm joint.

STEP 10: Remove tethered locking pin from front left support post and allow it to hang. Rotate spring loaded monitor support “K” bracket 48 out towards the front left support post 54. Align monitor support “K” bracket hinge 48 barrels 88 with hinge barrels 98 on front left support post 54 by slightly lifting 2×2 monitor drawer. Once barrels are aligned, re-insert tethered support post locking pin 98.

STEP 11: Near back right of drawer, release swivel latch 136 on back of 4 monitor stack. CAUTION: During monitor rotation in STEP 12, lift and support monitors with both hands due to the total weight of all four monitors. The articulating monitor assembly 10 will support the weight but a sudden release of the 4 monitor stack could torque and bend components which impact operation and monitor alignment.

STEP 12: Rotate 4 monitor stack 90 degrees with both hands to forward position.

In the foregoing description, certain terms have been used for brevity, clearness, and understanding. No unnecessary limitations are to be implied therefrom beyond the requirement of the prior art because such terms are used for descriptive purposes and are intended to be broadly construed. Therefore, the invention is not limited to the specific details, the representative embodiments, and illustrative examples shown and described. Thus, this application is intended to embrace alterations, modifications, and variations that fall within the scope of the appended claims.

Moreover, the description and illustration of the invention is an example and the invention is not limited to the exact details shown or described. References to “the preferred embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in the preferred embodiment” does not necessarily refer to the same embodiment, though it may.

What is claimed is:

1. A monitor bracket assembly comprising:
a first monitor frame;
a second monitor frame;
a third monitor frame;
a fourth monitor frame;
a generally transverse frame first hinge pivotably coupling the first monitor frame to the second monitor frame;
a generally transverse frame second hinge pivotably coupling the third monitor to frame to the fourth monitor frame; and
a generally vertical frame third hinge pivotably coupling the second monitor frame to the third monitor frame;
wherein the monitor bracket assembly is adapted to deploy four monitors respectively attached to the first, second, third, and fourth monitor frames from a folded and stored first position to an unfolded 2×2 second position.

2. The monitor bracket assembly of claim 1, further comprising:
a sliding first rail and a sliding second rail spaced apart from each other;
a tray connected to the first and second rails;
a monitor group support plate to which the four monitor frames are coupled;
a generally longitudinal monitor group first hinge coupling the monitor group support plate to the tray.

3. The monitor bracket assembly of claim 2, further comprising:
a forward first end on the monitor group support plate;
a bracket including a first end pivotably coupled to the forward first end on the monitor group support plate, the bracket moveable between a collapsed position and an extended position;
wherein the bracket is disposed between the monitor group support plate and the tray in the collapsed position; and
wherein the bracket extends transversely between the first and second rails supporting the monitor group support plate in the extended position and extends longitudinally parallel to the first and second rails in the collapsed position.

4. The monitor bracket assembly of claim 3, further comprising:
a rear second end on the monitor group support plate;
a rear monitor support arm connected adjacent the rear second end on the monitor group support plate and extending transversely between the first and second rails supporting the monitor group support plate in the extended position longitudinally rearward from the bracket.

5. The monitor bracket assembly of claim 3, further comprising:
a spring between the bracket and the monitor group support plate to bias the bracket from the extended position to the collapsed position.

6. The monitor bracket assembly of claim 3, further comprising:
a support tab on one of the four monitor frames;
a support post extending vertically from a rigid connection with the first slide rail;
the support post defining a slot, the slot receiving the support tab therethrough in the unfolded 2×2 second position; and
a vertical barrel on the post configured to align with a barrel on the bracket in the unfolded 2×2 second position.

7. The monitor bracket assembly of claim 3, further comprising:
a support post extending vertically from a rigid connection with the first slide rail including a first barrel;
a bracket second end including a second barrel;
wherein to secure the bracket in the extended position, a user must manually align the first and second barrels by lifting the bracket upwardly and insert a pin to secure the two aligned barrels together.

8. The monitor bracket assembly of claim 3 wherein the bracket is a K-bracket.

9. The monitor bracket assembly of claim 2, further comprising:
a forward first end on the monitor group support plate;
a generally vertical monitor group second hinge adjacent the forward first end coupling the first monitor frame to the monitor group support plate.

10. The monitor bracket assembly of claim 2, further comprising:
a block lock to lock a forward end of the first slide rail to prevent longitudinal movement of the four monitor frames when in the stored first position.

11. The monitor bracket assembly of claim 2, further comprising:
a compression lock connected to the tray and partially circumscribing the monitor frames to prevent at least one of transverse and vertical movement of the four monitor frames when in the stored first position.

12. The monitor bracket assembly of claim 1, further comprising:
an electrical raceway defined by the first, second, third, and fourth monitor frames adapted to receive wiring therethrough and adapted to enclose the wiring when the monitors are deployed such that the wiring is generally not seen by a user.

13. The monitor bracket assembly of claim 1, further comprising:
a pair of outer side rails adapted to be fixedly attached inside a case;
a pair of intermediate slide rails slidably engaged with the outer slide rails to telescope longitudinally;
a pair of main slide rails slidably engaged with the intermediate rails that telescope longitudinally;
a tray fixedly connected and extending transversely between the pair of main slide rails to slide in unison therewith; and
a monitor group support plate to which the four monitor frames are coupled.

14. The monitor bracket assembly of claim 1, further comprising:
a first tension spring including first and second ends, the first end coupled to a case frame and the second end coupled to electrical wiring, the spring pulling the wiring out of the way of the four monitor frames as the frames slide longitudinally into the case towards the folded and stored first position.

15. The monitor bracket assembly of claim 1, further comprising:
a vertical height in the stored first position less than or equal to six rack units.

16. The monitor bracket assembly of claim 1, further comprising:
a vertically stacked configuration of the four monitor frames in the stored first position;
wherein the first monitor frame is the vertically lowest of the four monitor frames relative to the stack of four frames in the stored first position; and
wherein the fourth monitor frame is the vertically highest of the four monitor frames relative to the stack of four frames in the stored position.

17. The monitor bracket assembly of claim 1, further comprising:
a transverse plane in the unfolded second position wherein each of the four monitor frames lies in the plane and adapted to not allow the four monitors in the frames to bend out of the plane.

18. The monitor bracket assembly of claim 1, further comprising:
a center of gravity in the unfolded second position longitudinally rearward of each of the four monitor frames.

19. The monitor bracket assembly of claim 1, further comprising:
a first finger flange on the second monitor frame;
a second finger flange on the third monitor frame; and
wherein the finger flanges are adapted to allow a user to slide the monitor outwardly from the stored positon in the case by pulling on the flinger flanges.

20. A method comprising the steps of:
providing a monitor bracket assembly mounted in a case to a user, wherein the bracket assembly configured to move between a folded and stored first position to an unfolded 2×2 second position;
affecting the user to longitudinally draw a monitor frame on the bracket assembly in a stored position outwardly from the case; and
affecting the user to pivot the monitor frame about a hinge to deploy the frame associated with the unfolded 2×2 position.
